(19) United States
(12) Patent Application Publication
(10) Pub. No.: US 2019/0010428 A1
(43) Pub. Date: Jan. 10, 2019

(54) COATED BLEACH CATALYST(S)

(71) Applicant: Dalli-Werke GmbH & Co. KG, Stolberg (DE)

(72) Inventors: Katja TILLMANN, Baesweiler (DE); Torsten BIELEN, Recht (BE); Stefan MÜLLER, Köln (DE)

(21) Appl. No.: 16/068,353

(22) PCT Filed: Dec. 13, 2016
(86) PCT No.: PCT/EP2016/080820

§ 371 Date: Jul. 5, 2018

(30) Foreign Application Priority Data
Jan. 6, 2016 (EP) 16150299.2

(51) Int. Cl. C11D 3/39; C11D 17/00

(52) U.S. Cl. CPC C11D 3/3935; C11D 17/0039

(57) ABSTRACT

Provided is a granule containing a core containing one or more bleach catalyst(s), one or more binder(s), optionally a bleach activator and further a coating a containing a polymer or a carboxylic acid as well as a detergent composition containing such a granule, a method for preparing the granule and the use of such a granule in cleaning compositions.

The present invention refers to a granulate comprising a core comprising or consisting of one or more bleach catalyst(s), one or more binder(s), optionally a bleach activator and further a coating comprising or consisting of a polymer or a carboxylic acid as well as a detergent composition comprising such a granulate, a method for preparing said granulate and the use of such a granulate in cleaning compositions.

In cleaning compositions often a bleach system is included to bleach coloured soiling. Such a bleaching system usually comprises any compound representing or developing a bleaching agent, further a bleach activator and a bleach catalyst to support and facilitate the bleaching effect of the bleaching agent.

When inorganic peroxygen based bleaching agents are applied, a bleach activator provides the possibility to use a comparatively low temperature to achieve the desired bleaching performance. The bleach activator reacts with the peroxygen to form an organic peracid. Depending from the used bleach activator these peracids can have a hydrophobic or a hydrophilic character.

To be able to provide the bleaching action at a desired stage during the cleaning process, the compounds of the cleaning system often are separated from each other. Further the separation of the compounds increases the stability during storage. In particular it is preferable to separate the bleach catalyst and/or the bleach activator from the bleaching agent.

Several bleaching catalysts, in particular such catalysts comprising a metal ion, are sensitive concerning their stability. Therefore it is an ongoing problem to stabilize said catalysts in a way allowing their storage, but ensuring their fast effectiveness when needed during cleaning processes.

One group of usually used catalysts are those comprising manganese, as this metal is less toxic than for example cobalt. Such compounds are well known in the art and include, for example, the manganese-based catalysts disclosed in U.S. Pat. No. 5,246,621, U.S. Pat. No. 5,244,594; U.S. Pat. No. 5,194,416; U.S. Pat. No. 5,114,606; and EP-A 549 271, EP-A 549 272, EP-A 544 440, and EP-A 544 490. Other metal-based bleach catalysts include those disclosed in U.S. Pat. No. 4,430,243 and U.S. Pat. No. 5,114,611. The use of manganese with various complex ligands to enhance bleaching is also reported in the following U.S. Pat. Nos. 4,728,455; 5,284,944; 5,246,612; 5,256,779; 5,280,117; 5,274,147; 5,153,161; and 5,227,084.

The bleach catalysts useful in cleaning compositions like machine dishwashing compositions and concentrated powder detergent compositions may also be selected as appropriate for the present invention. For examples of suitable bleach catalysts see U.S. Pat. No. 4,246,612 and U.S. Pat. No. 5,227,084.

Moreover, WO 97/22681 discloses automatic dishwashing detergent (ADD) compositions as compact granular, phosphate-free or phosphate-containing and chlorine bleach-free types incorporating metal-containing bleach catalysts, preferably catalysts containing manganese and/or selected cobalt/ammonia catalysts, as well as fully-formulated automatic dishwashing detergent compositions with enzymes.

Additionally, WO 97/22680 discloses composite particles comprising a bleach catalyst plus one or more enzymes suitable for incorporation into detergent compositions.

Although being very effective in promoting cleaning properties of automatic dishwashing detergent compositions, enzymes have to be protected from oxidation caused by the components of an oxygen bleach system, namely the source of hydrogen peroxide and an activator. Therefore, WO 98/55577 discloses the physical separation of components of the bleach system and an enzyme-containing core by a barrier layer. Said enzyme containing core may further include a bleach catalyst system.

A major disadvantages of the above cited prior art is that it is more focused on improving the dishwashing performance of automatic dishwashing detergent compositions by increasing stability of the incorporated enzymes. Attention is usually not drawn to the stability of the metal containing bleach catalyst in such automatic dishwashing compositions.

WO 2010/115581A1 discloses a bleach granule containing (a) at least one bleach activator, (b) at least one metal-containing bleach catalyst and (c) at least 5 wt.-% of at least one organic acid in form of a co-granulate. It is mentioned that the co-granulate might be coated, however no coating materials are disclosed.

WO 2010/115582A1 describes co-granules containing a granule core an a sheath or coating layer surrounding the granule core. Said co-granules are characterised in that the granule core contains a) at least one bleach activator, b) optionally a bleach catalyst and c) at least one binding agent, whereas the sheath or coating layer contains d) between 80 and 100 wt.-% of the total quantity of the at least one bleaching catalyst contained in the co-granule and further (e) a coating agent.

It has been found that the storage, especially the long-term storage, of metal containing bleach catalysts in cleaning compositions, e.g. dishwashing compositions is difficult as cleaning performance decreases significantly upon storage over a few weeks. Therefore, it would be highly desirable to stabilize metal containing bleach catalysts, specifically designed to be compatible in ADD formulations, even for a long-term storage.

Therefore the problem underlying the present invention was to provide a system usable in modern cleaning compositions allowing the separation of bleach catalyst and optionally bleach activator from the bleaching agent, wherein the bleach catalyst remains particularly stable, however, is fast and effectively released when needed.

This object is met by providing a co-granulate comprising
(A) a core comprising or consisting of:
   a) at least one metal-containing bleach catalyst;
   b) at least one binder, preferably selected from cellulosic polymers, more preferably selected from carboxymethyl cellulose, hydroxypropyl cellulose, hydroxypropylmethyl cellulose, and mixtures thereof;
   c) optionally at least one bleach activator; and
(B) a coating comprising or consisting of: at least one of the components selected from
(i) polyvinyl alcohol (PVA), copolymers of PVA and polyethylene glycol (PEG), polyvinyl acetate, polyvinylpyrrolidone, ethylenvinylalcohol, sodium lauryl sulfate, or
(ii) an acid component, selected from acid polymers particularly copolymers comprising sulfonic acid groups, like for example copolymers comprising acrylic acid and sulfonic acid monomers, and carboxylic acids, preferably mono-, di- or tricorboxylic acids comprising 2 to 15, preferably 3 to 10, more preferred 3 to 8 C atoms, preferably citric acid or citrate, and mixtures thereof.

### (A) Core

According to the present invention the co-granulate comprises the bleach catalyst in the core of the coated particles, whereas preferably the coating doesn't comprise any amount of the bleach catalyst. The core of the co-granulate may represent 0.5 to 99 wt.-% of the co-granulate, preferably 1 to 98 wt.-&, more preferred 2, 3, 4, 5, 10, 15, 20, 25, 30, 35, 40, 45, 50, 55 or 60 wt.-% to 65, 70, 75, 80, 85, 90, 95, 96 or 97 wt.-% of the co-granulate. The ingredients of the core can be present in any suitable amount and mixture, preferably in the ranges defined below.

### (a) Bleach Catalyst

The core of the granular particle of the present invention comprises at least one metal containing bleach catalyst, preferably selected from bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts. Such catalysts are broadly discribed in the state of the art, well known by skilled artisans.

In U.S. Pat. No. 4,430,243 one type of metal-containing bleach catalyst is disclosed which is a catalyst system comprising a transition metal cation of defined bleach catalytic activity, such as copper, iron, titanium, ruthenium tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof.

Other types of bleach catalysts include the manganese-based complexes disclosed in U.S. Pat. No. 5,246,621 and U.S. Pat. No. 5,244,594. Preferred examples of theses catalysts include Mn^{IV}₂(μ-O)₃(1,4,7-trimethyl-1,4,7-triazacyclononane)₂-(PF₆)₂ (“MnTACN”), Mn^{III}₂(μO)₁(μ-OAc)₂(1,4,7-trimethyl-1,4,7-triazacyclononane)₂-(ClO₄)₂, Mn^{IV}₄(μO)₆(1,4,7-triazacyclononane)₄-(ClO₄)₂, Mn^{III}Mn^{IV}₄(μ-O)₁(μ-OAc)₂(1,4,7-trimethyl-1,4, 7-triazacyclononane)₂-(ClO₄)₃, and mixtures thereof. See also European patent application EP 549,272. Other ligands suitable for use herein include 1,5,9-trimethyl-1,5,9-triazacyclododecane, 2-methyl-1,4,7-triazacyclononane, 2-methyl-1,4,7-triazacyclononane, and mixtures thereof and mixtures of pentaamineacetate cobalt (III) nitrate and MnTACN.

The bleach catalysts useful in automatic dishwashing compositions and concentrated powder detergent compositions may also be used in present invention. For examples of suitable bleach catalysts see U.S. Pat. No. 4,246,612 and U.S. Pat. No. 5,227,084, or U.S. Pat. No. 5,194,416 which teaches mononuclear manganese (IV) complexes such as Mn(1,4,7-trimethyl-1,4,7-triazacyclononane(OCH₃)₃₋(PF₆).

Still another type of bleach catalyst, as disclosed in U.S. Pat. No. 5,114,606, is a water-soluble complex of manganese (II), (III), and/or (IV) with a ligand which is a non-carboxylate polyhydroxy compound having at least three consecutive C—OH groups. Preferred ligands include sorbitol, iditol, dulsitol, mannitol, xylitol, arabitol, adonitol, meso-erythritol, meso-inositol, lactose, and mixtures thereof.

U.S. Pat. No. 5,114,611 teaches a bleach catalyst comprising a complex of transition metals, including Mn, Co, Fe, or Cu, with an non-(macro)-cyclic ligand. Said ligands are of the formula: R¹R²N═C—B(R³)—C═NR⁴, wherein R¹, R², R³, and R⁴ can each be selected from H, substituted alkyl and aryl groups such that each R¹—N═C—R² and R³—C═N—R⁴ form a five or six-membered ring. Said ring can further be substituted. B is a bridging group selected from O, S, CR⁵R⁶, NR' and C═O, wherein R⁵, R⁶, and R⁷ can each be H, alkyl, or aryl groups, including substituted or unsubstituted groups. Preferred ligands include pyridine, pyridazine, pyrimidine, pyrazine, imidazole, pyrazole, and triazole rings. Optionally, said rings may be substituted with substituents such as alkyl, aryl, alkoxy, halide, and nitro. Particularly preferred is the ligand 2,2′-bispyridylamine. Preferred bleach catalysts include Co, Cu, Mn, Fe,-bispyridylmethane and-bispyridylamine complexes. Highly preferred catalysts include Co(2,2′-bispyridylamine)Cl₂, Di(isothiocyanato)bispyridylamine-cobalt (II), trisdipyridylamine-cobalt(II) perchlorate, Co(2,2-bispyridylamine)₂O₂ClO₄, Bis-(2,2′-bispyridylamine) copper(II) perchlorate, tris(di-2-pyridylamine) iron(II) perchlorate, and mixtures thereof.

Other examples include Mn gluconate, Mn(CF₃SO₃)₂, Co(NH₃)₅Cl, and the binuclear Mn complexed with tetra-N-dentate and bi-N-dentate ligands, including N₄Mn^{III}(μ-O)₂Mn^{IV}N₄)⁺ and [Bipy₂Mn^{III}(μO)₂Mn^{IV}bipy₂]-(ClO₄)₃.

Complexes of manganese in the valence state II, III, IV or V which preferably comprise one or a plurality of macrocyclic ligands with the donor functions N, NR, PR, O and/or S are particularly preferably employed. Ligands having nitrogen donor functions are preferably employed. In this regard, it is particularly preferred to select the at least one bleach catalyst from such having a group 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1, 4,7-triazacyclononane (Me/TACN) as the macromolecular ligands. Preferred manganese complexes are for example [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}4(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂ (MnTACN) and [Mn^{IV}₂(μ-O)₃(Me/Me-TACN)₂](PF₆)₂ (OAc═OC(O)CH₃).

Preferably, at least one metal containing bleach catalyst of the invention is MnTACN.

The bleach catalyst may amount from 0.01-85 wt.-% of the particle core, preferably it is present in an amount of 0.1-50 wt.-% of the core, more preferred in an amount of 0.2 to 20 wt.-%, even more preferred 0.5 to 10 wt.-%, even more preferred 0.8 to 5 wt.-%, and most preferred 1 to 3 wt.-% of the particle core.

### (b) Binder

As a binder any suitable compound can be used. Preferred examples of suitable binders are polymeric fillers like cellulose or derivatives thereof, in particular carboxymethyl cellulose, hydroxypropyl cellulose, hydroxypropylmethyl cellulose, and mixtures thereof; and starch and derivatives thereof. Particularly preferred the binder is carboxymethyl cellulose (CMC).

Another type of suitable binders are polymers of acrylic acid or methacrylic acid or copolymers of (meth)acrylic acid with other acid or nonionic monomers, e.g. olefinic monomers. Examples of such copolymers are (meth)acrylic acid-olefinic copolymers, (meth)acrylic acid-maleic acid copolymers, without being limited the these mentioned.

Further suitable binders are the polymers described below as coating materials.

Furthermore as a binder a manganese-amino acid compound can be used, such as compounds described in the European patent application having the application number EP 15161672.9. By manganese-amino acid compound, a compound is meant that comprises or consists of a manganese, preferably a manganese ion such as, for example, Mn (II), is meant, that is bound to, associated with or complexed with at least one single amino acid or at least one amino acid residue being part of a protein.

Said manganese-amino acid compound preferably comprises manganese sulfate, preferably a manganese(II)sulfate monohydrate that is bound to, associated with or surrounded by an amino acid residue being part of a protein.

The term “bound to” refers to any kind of chemical bonding between the manganese and the amino acid or amino acid residue. In particular it refers to ionic interactions between ionic forms of the manganese and the amino acid or amino acid residue. The term “associated with” refers to non-covalent interactions between the manganese and the amino acid or amino acid residue; in particular to interactions based on van der Waals interactions, H-bonds and the like. The term “complexed with” refers to any kind of ligandization or chelation of the manganese or manganese ion by the amino acid or amino acid residue.

By “single amino acid” a monomeric amino acid that is not part of a protein is meant. With “at least one single amino acid” it is meant that more than one amino acid can be bound to or complexed with the manganese, however, the amino acid(s) is/are (a) single amino acid(s), monomers not being part of a protein. Preferred single amino acids are low molecular weight aliphatic amino acids, like e.g. glycine, alanine, valine, leucine or isoleucine or more hydrophilic amino acids like e.g. serine or threonine. Further, as well charged (chargable) amino acids can be used, like lysine, arginine and histdine and in particular due to their negative charge aspartate and glutamate. Asparagine or glutamine, however, are also suitable. The sulfur-comprising amino acids cysteine and methionine and the sterically restricted (proline) and/or aromatic amino acids (phenylalanine, tyrosine and tryptophane) can be used, however, are less preferred. A particular preferred amino acid is glycine.

By “manganese-single amino acid compound” it is referred to a compound comprising a manganese that is bound to, associate with or complexed with a single amino acid as specified above.

In a preferred embodiment, the manganese in the manganese-single amino acid compound is bound to, associated with or complexed with at least one single amino acid, whereas—if more than one amino acid is involved—the amino acids can differ from each other. E.g. one manganese in a manganese-single amino acid compound might be bound to, associated with or complexed with glycine forming manganese glycinate, whereas a further manganese in the manganese-single amino acid compound is bound to, associated with or complexed with another amino acid, e.g. aspartate, forming manganese aspartate. Such a mixture of manganese-single amino acid compounds can be used according to the present invention.

Preferably, at least one manganese ion, atom or compound is bound, associated with, or complexed by at least one single amino acid. Preferred manganese compounds are manganese (II) salts.

In a particularly preferred embodiment the manganese-single amino acid compound is provided in a form of a “manganese glycinate”, wherein preferably a manganese sulfate, particularly preferred a manganese(II)sulfate is bound to, associated with or complexed with a glycine. Such manganese glycinates up to now are known as dietary supplements or ingredients in food, particularly in food for animals and as fertilizers.

Further, the manganese-amino acid compound can be a manganese-proteinate, wherein the manganese-proteinate compound comprises a manganese bound to, associated with or complexed with at least one single amino acid residue that is part of a protein, e.g. such manganese proteinates as described in WO 2005/095570.

Preferably, the term “protein” within the proteinate does not refer to catalytic proteins depending on manganese for their activity such as dehydrogenases, oxidases, reductases, transferases, synthases, isomerases, kinases, lyases, ligases, cyclases, peptidases, hydrolases, phosphatases, phospodiesterases, carboxylases, decarboxylases, catalases, and super oxide dismutases that carry a manganese ion in their active site. More preferably the term “protein” with respect to the proteinate does not comprise any functional enzymes. The protein can comprise any three dimensional structure or can be a random coil.

Preferably, in the manganese-proteinate at least one manganese ion, atom or compound is bound to, associated with, contained in or surrounded by the protein. More preferred at least two, particularly preferred at least four manganese ions, atoms or compounds are contained. Preferred manganese compounds are manganese (II) salts.

A particularly preferred Manganese-proteinate is a product called “Proteinato di Manganese”, available from SICIT 2000 S.p.A., Chiampo, Italy. Such manganese proteinates are known as ingredients in animal food, particularly in food for cattle, and for use as fertilizer.

### (c) Bleach Activator

Bleach activator agents that can be used in co-granulates and cleaning compositions of the present invention include, but are not limited to, tetraacetylethylenediamine (TAED), sodium nonanoyloxybenzene sulfonate (NOBS), acetyl caprolactone, N-methyl morpholinium acetonitrile and salts thereof, sodium 4-(2-decanoyl-oxyethoxycarbonyloxy)benzenesulfonate (DECOBS) and salts thereof, lauryloxybenzylsulfonate (LOBS), iso-lauryloxybenzylsulfonate (I-LOBS), N-methylmorpholinum-acetonitril (MMA), Pentaacetylglucose, Nitrilquats, Benzoylcaprolactam (BzCL), 4-nitrobenzoylcaprolactam, 3-clorobenzoylcaprolactam, benzoyloxybenzylsulfonate (BOBS), phenylbenzoate (Ph Bz), decanoyloxybenzylsulfonate (C10-OBS), benzoylvalerolactam (BZVL), octanoyloxybenzylsulfonate (C8-OBS), 4-[N-(nonanoyl)aminohezanoyloxy]-benzylsulfonate-sodium salt (NACA-OBS), 10-undecenoyloxybenzylsulfonate (UDOBS), decanoyloxybenzoec acid (DOBA), perhydrolyzable ester, perhydrolytic enzyme combined with an by this enzyme hydrolysable substrate, acetyl caprolactone, Acetyl caprolactam (N-acetylhexanelactam) (e.g. Peractive LAC) N-methyl morpholinium acetonitrile and salts thereof (such as Sokalan BMG from BASF).

Preferably TAED is selected as bleach activator.

If present, the bleach activator in the core of the particle might represent up to 75 wt-% of the particle core, e.g. in an amount of 0.1 to 70 wt.-%, 0.5 to 60 wt.-%, 1 to 50 wt.-% or any other suitable amount.

### (B) Coating

The “coating” according to the present invention is the outermost layer on the surface of the granulate particle, comprising or consisting of at least one water soluble coating material as defined below. The coating covers the “core” of the granulate particle. The coating thus protects the bleach catalyst and optionally the bleach activator from any contact with air or other ingredients of cleaning compositions. It is particularly preferred that the coating doesn't comprise any amount of the bleach catalyst. The coating may amount from 1 to 95 wt.-% of the granular particle, this means any range of 1, 2, 3, 4 or 5 wt.-% up to 8, 10, 12, 15, 20 or 25 wt.-%, up to 30, 35, 40, 45 or 50 wt.-%, or up to 55, 60, 65, 75 wt.-% or up to 95 wt.-% of the granular particle.

With “water soluble coating” it is meant that a layer of the coating material having a thickness of 100 μm will be dissolved in distilled water at 20° C. under agitation within 20 min, preferably within 10 min, more preferably within 5 min and most preferably within 2 min. Accordingly, due to fast solubility of the coating the catalyst will be released from the particle of the present invention in an appropriate time range. The “coating” may comprise besides the water soluble compound other ingredients, e.g. at least one further polymer and/or at least one surfactant, however, no metal containing bleach catalyst. Thus, according to the invention the bleach catalyst is not comprised in the outer coating of the granulate particle and thus have no contact to other detergent ingredients which are not part of the particle as long as the water soluble coating is not dissolved. Suitable polymers for coating are described herein below. Particularly suitable are dispersant polymers, film forming polymers and surfactants having a melting point of at least 30 ° C. or above.

The thickness of the coating layer preferably is at least 10 nm, more preferably at least 100 nm, even more preferred at least 1 μm and most preferred at least 10 μm, whereas the coating preferably is at most 1 mm, more preferably at most 800 μm, even more preferred at most 500 μm and most preferred at most 200 μm.

Preferred water soluble compounds are water soluble organic polymers or acid compounds as defined below.

One type of preferred water soluble organic polymers are represented by (i) at least one of the components selected from polyvinyl alcohol (PVA), copolymers of PVA and polyethylene glycol (PEG), polyvinyl acetate, polyvinylpyrrolidone and ethylenvinylalcohol. A further type of preferred water soluble coating compounds is (ii) an acid compound, like e.g. a polymer comprising sulfonic acid groups containing monomers, sodium lauryl sulfate or polycarboxylates, in particular mono-, di- or tricarboxylic acids and salts and/or mixtures thereof.

In a preferred embodiment component (i) is a mixture of a polyvinyl alcohol-polyethylene glycol graft copolymer and polyvinyl alcohol, more preferred said component (i) comprises or consists of a polyvinyl alcohol-polyethylene glycol graft copolymer, polyvinyl alcohol and silicon dioxide. Such a mixture of components is commercially available as Kollicoat Protect from BASF AG, Ludwigshafen, Germany.

As component (ii) an acidic component is used, which may be preferably a sulfonic acid group-containing polymer, in particular those from the group of the copolymeric polysulfonates. These copolymeric polysulfonates contain usually, besides sulfonic acid group-containing monomer(s), at least one monomer from the group of the unsaturated carboxylic acids.

Unsaturated carboxylic acids of the formula R¹(R²)C═C(R³)COOH are used with particular preference as (an) unsaturated carboxylic acids(s), in which formula R¹ to R³, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴ where R⁴ is a saturated or unsaturated, straight-chain or branched hydrocarbon residue having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid, or mixtures thereof. The unsaturated dicarboxylic acids are of course also usable.

In the context of the sulfonic acid group-containing monomers, those of the formula R⁵(R⁶)C═C(R⁷)—X—SO₃H, in which R⁵ to R⁷, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or denote —COOH or —COOR⁴, where R⁴ is a saturated or unsaturated, straight-chain or branched hydrocarbon residue having 1 to 12 carbon atoms, and X denotes an optionally present is spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H, in which R⁶ and R⁷, mutually independently, are selected from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

The sulfonic acid groups can be present in the polymers entirely or partly in neutralized form. The use of partly or entirely neutralized sulfonic acid group-containing copolymers is preferred.

The molecular weight of the sulfo-copolymers can be varied in order to adapt the properties of the polymers to the desired application. Preferred automatic dishwashing agents are characterized in that the copolymers have molecular weights from 2.000 to 200.000 gmol⁻¹, preferably from 4.000 to 25.000 gmol⁻¹, and in particular from 5.000 to 15.000 gmol⁻¹.

A particular suitable polymer is Accusol™ 588 of Rohm & Haas.

The copolymers can also encompass, besides carboxyl group-containing monomers and sulfonic acid group-containing monomers, at least one nonionic, preferably hydrophobic monomer. The use of these hydrophobically modified polymers allows to improve, in particular, the rinsing performance of automatic dishwashing agents according to the present invention.

Cleaning agents containing a copolymer encompassing
i) carboxylic acid group-containing monomer(s),
ii) sulfonic acid group-containing monomer(s),
iii) optionally (a) nonionic monomer(s), are preferred according to the present invention.

The use of these terpolymers has made it possible to improve the rinsing performance of automatic dishwashing agents according to the present invention with respect to comparable dishwashing agents that contain sulfopolymers without the addition of nonionic monomers.

The nonionic monomers used are preferably monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms.

Particularly preferred nonionic monomers are butene, isobutene, pentene, 3-methylbutene, 2-methylbutene, cyclopentene, hexene, hexene-1, 2-methlypentene-1, 3-methlypentene-1, cyclohexene, methylcyclopentene, cycloheptene, methylcyclohexene, 2,4,4-trimethylpentene-1, 2,4,4-trimethylpentene-2, 2,3 -dimethylhexene-1,2, 4-dimethylhexene-1, 2,5-dimethlyhexene-1, 3,5-dimethylhexene-1, 4,4-dimethylhexane-1, ethylcyclohexyne, 1-octene, α-olefins having 10 or more carbon atoms such as, for example, 1-decene, 1-dodecene, 1-hexadecene, 1-octadecene, and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinyl naphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

Further compounds suitable as an acid coating compound (ii) are polycarboxylic acids or their salts, preferably comprising 2 to 15, more preferred 3 to 10, even more preferred 3 to 8 C atoms. In particular mono-, di- or tricarboxylic acids are preferred. Examples of such acids encompass saturated as well as unsaturated polycarboxylic acids, in particular such having 2 to 8 carbon atoms. Included among this group are acetic acid and propionic acid, oxalic acid, lactic acid, malonic acid, maleic acid, succinic acid, malic acid, tartaric acid, aspartic acid and citric acid. Preferred carboxylic acids of the invention are citric acid, succinic acid, maleic acid, malonic acid and malic acid, wherein citrate or citric acid is preferred.

The co-granulate according to the invention may be prepared by mixing the bleach catalyst and the binder, granulating said mixture by any suitable method known in the art, and coating said granule with the coating material, e.g. by applying a solution of the coating material and drying the granules.

### Further Ingredients of Cleaning Compositions

The cleaning composition(s) of the present invention may further comprise any of the ingredients known in the art as common ingredients in detergent cleaning compositions, particularly in automatic dishwashing compositions. Such at least one further ingredient is selected from the group consisting of e.g. builders, surfactants, preferably non-ionic and/or anionic surfactants, polymers/cobuilders, enzymes, complexing agents, bleaching agents, bleach activators, dispersing agents, optical brighteners, stabilizers, colorants, odorants, anti-redeposition agents, anti-corrosion agents, tableting agents, disintegrants, silver protecting agents, dyes, and perfume, without any restriction.

Furthermore, all of the optional ingredients known in the state of the art to be effective or usable in detergent compositions, particular in automatic dishwashing compositions might be included.

Said further ingredients are not limiting the present invention.

The following further ingredients can be included in a cleaning composition of the present invention, or can be ingredients of a detergent composition combined with said granulate particle of the present invention.

### Builder(s), Co-Builder(s), Complexing Agents

The composition of the present invention preferably comprise one or more builder(s) as at least one further ingredient.

The main functions of the builders are to soften the washing water, to provide alkalinity and a buffering capacity to the washing liquid and to have an anti-redeposition or dispersing function in the cleaning composition. The physical properties of the cleaning composition are also depending on the builders that are used.

For controlling the pH of the composition, as well as its mineral hardness, inorganic as well as organic builders may be incorporated into the composition. In addition, these builders may assist in the removal of particulate soil. If present in the composition according to the present invention, the builder or the mixture of builders preferably will be present in an amount of from 0.1 to 90 wt.-%, preferably in an amount of from 5-80 wt.-%, more preferably in an amount of 8-70 wt.-%, and even more preferably in an amount of from 10-50 wt.-%, based on the whole composition.

Included among the builders in this context are, in particular, the silicates, aluminosilicates, carbonates, sulfates, organic co-builders, and-in cases where no environmental prejudices against their use exist-also the phosphates. Suitable phosphate builders include alkaline, ammonium or alkanolammonium salts of polyphosphates, including tripolyphosphates, pyrophosphates and polymeric meta-phosphates. In one embodiment, the composition of the present invention comprises less than 5 wt.-% of a polyphosphate builder, based on the whole composition.

Among the plurality of commercially obtainable phosphates, the alkali metal phosphates have the highest importance for the agents according to the present invention, with particular preference for pentasodium triphosphate, Na₅P₃O₁₀ (sodium tripolyphosphate) resp. pentapotassium triphosphate, K₅P₃O₁₀ (potassium tripolyphosphate).

If phosphates are used, the weight proportion of the phosphate in terms of the total weight of the cleaning composition is preferably from 1 to 70 wt.-%, more preferably from 10 to 60 wt.-%, and most preferred from 20 to 50 wt.-%.

In addition to or instead of an inorganic builder the composition of the present invention may as well comprise an organic detergent builder, including polycarboxylate builders in the form of their acid or a salt, including alkali metal salts such as potassium, sodium and lithium salts.

The group of preferred builders includes in particular the citrates as well as the carbonates and the organic co-builders. The term “citrate” hereby includes both citric acid as well as its salts, in particular its alkali metal salts.

Carbonate(s) and/or hydrogen carbonate(s), preferably alkali metal carbonate(s), particularly preferably sodium carbonate, are particularly preferably added in quantities of 5 to 70 wt.-%, preferably 10 to 40 wt.-% and especially 15 to 60 wt.-%, each relative to the weight of the dishwashing agent.

Polycarboxylates/polycarboxylic acids and phosphonates may be particularly mentioned as the organic co-builders. These classes of substances are described below.

Useful organic builders are, for example, the polycarboxylic acids that can be used in the form of the free acid and/or their sodium salts, polycarboxylic acids in this context being understood to be carboxylic acids that carry more than one acid function. These include, for example, adipic acid, succinic acid, glutaric acid, malic acid, tartaric acid, maleic acid, fumaric acid, sugar acids, amino carboxylic acids, nitrilotriacetic acid (NTA) and mixtures thereof. Besides their building effect, the free acids also typically have the property of an acidifying component and hence also serve to establish a relatively low and mild pH of the inventive agents. Succinic acid, glutaric acid, adipic acid, gluconic acid and any mixtures thereof are particularly to be mentioned in this regard.

Usable organic builder substances are, for example, the polycarboxylic acids usable in the form of the free acid and/or sodium salts thereof, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, besides their builder effect, the property of an acidifying component, and thus also serve to establish a lower and milder pH for washing or cleaning agents. To be recited in this context are, in particular, citric acid, succinic acid, glutaric acid, adipic acid, gluconic acid, and any mixtures thereof.

Citric acid or salts of citric acid are used with particular preference as a builder substance.

A further particularly preferred builder substance is methylglycinediacetic acid (MGDA). According to the invention it is particularly preferred to add MGDA as at least one builder/complexing agent into the composition.

Also suitable as builders are polymeric polycarboxylates; these are, for example, the alkali metal salts of polyacrylic acid or of polymethacrylic acid, for example those having a relative molecular weight from 500 to 70.000 g/mol or derivatives thereof.

The molecular weight indicated for polymeric polycarboxylates are herein weight-average molecular weights Mw of the respective acid form that were determined in principle by means of gel permeation chromatography (GPC), a UV detector having been used. The measurement was performed against an external polyacrylic acid standard that yields realistic molecular weight values because of its structural affinity with the polymers being investigated.

Suitable polymers are, in particular, polyacrylates that preferably have a molecular weight from 2.000 to 20.000 g/mol. Of this group in turn, the short-chain polyacrylates, which have molecular weights from 2.000 to 10.000 g/mol and particularly preferably from 3.000 to 5.000 g/mol, may be preferred because of their superior solubility.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt.-% acrylic acid and 50 to 10 wt.-% maleic acid have been found particularly suitable. Their relative molecular weight, based on free acids, is equal to in general 2.000 to 70.000 g/mol, preferably 20.000 to 50.000 g/mol, and in particular 30.000 to 40.000 g/mol.

Oxydisuccinates and other derivatives of disuccinates, preferably ethylenediamine disuccinate, are additional suitable co-builders. Ethylenediamine-N,N′-disuccinate (EDDS might be used, preferably in the form of its sodium or magnesium salts. Also preferred in this context are glycerol disuccinates and glycerol trisuccinates.

In order to improve cleaning performance and/or to adjust viscosity, liquid cleaning agents may contain at least one hydrophobically modified polymer, preferably a hydrophobically modified polymer containing carboxylic acid groups, the weight amount of the hydrophobically modified polymer in terms of the total weight of the cleaning agent being preferably 0.1 to 10 wt.-%, preferably between 0.2 and 8.0 wt.-%, and in particular 0.4 to 6.0 wt.-%.

Supplementing the builders described above, polymers having cleaning activity can be contained in the cleaning agent. The weight proportion of the polymers having cleaning activity in terms of the total weight of automatic cleaning agents according to the present invention is preferably from 0.1 to 20 wt.-%, preferably 1.0 to 15 wt.-%, and in particular 2.0 to 12 wt.-%.

One of the preferred polymers providing cleaning activity are those sulfonic acid-group containing acidic polymers described above for coating the core of the co-granulates of the invention.

The weight proportion of the sulfonic acid group-containing copolymers in terms of the total weight of cleaning agents according to the present invention is preferably from 0,1 to 15 wt.-%, preferably from 1.0 to 12 wt.-%, and in particular from 2.0 to 10 wt.-%.

Organic co-builders that may be recited are in particular polycarboxylates/polycarboxylic acids, polymeric polycarboxylates, aspartic acid, polyacetals, dextrins or further organic co-builders.

### Complexing Agents

A further preferred ingredient of cleaning compositions is at least one complexing agent. The cleaning composition of the present invention may optionally comprise one or more complexing agent(s) as at least one further ingredient.

Complexing agents are commonly used as co-builders to support the performance of the builders.

A function of complexing agents is to capture trace metal ions like, Cu(II), Fe(II), Fe(III), Mn(II), Cd(II), Co(II), Cr(III), Hg(II), Ni(II), Pb(II), Pd(II), Zn(II), Ca(II), Mg(II) These ions can interfere with or disturb certain processes of the detergent in the washing machine, like e.g. the bleach performance.

The complexing agent(s) that are known to be used in detergent compositions include, but are not limited to S,S-ethylenediamine-N,N′-disuccinic acid (S,S-EDDS), ethylenediaminetetraacetic acid (EDTA), diethylene triamine penta(methylene phosphonate) (DETPMP), nitrilotriacetic acid (NTA), ethanol diglycine (EDG), imino disuccinic acid (IDS), methylglycine diacetic acid (MGDA), diethylene triamine pentaacetic acid (DTPA), ethylene diamine dihydroxyphenyl acetic acid (EDDHA), N-(hydroxyethyl) ethylenediamine triacetic acid (HEDTA), hydroxyethylidene-1,1-diphosphonic acid (HEDP), phytic acid, diethylene triamine (DETA), triethylene tetramine (TETA), tetraethylene pentamine (TEPA), aminoethyl ethanolamine (AEEA), glutamic acid N,N-diacetic acid (GLDA), 1,3-propylenediamine tetraacetic acid (PDTA), glucoheptonic acid, dipicolinic acid, ethylene diamine tetra (methylene phosphonic acid) (EDTMPA), 2-hydroxyethyliminodiacetic acid (HEIDA) or water soluble salts thereof or mixtures thereof.

Further, phosphonates are preferred complexing agents. Useful phosphonates encompass, besides 1-hydroxyethane-1,1-diphosphonic acid, a number of different compounds such as, for example, diethylenetriaminepenta(methylenephosphonic acid) (DTPMP). Hydroxyalkane-or aminoalkanephosphonates are preferred in this Application. Among the hydroxyalkanephosphonates, 1-hydroxyethane-1,1-diphosphonate (HEDP) is of particular importance as a co-builder. It is used preferably as a sodium salt, the disodium salt reacting neutrally and the tetrasodium salt in alkaline fashion (pH 9). Suitable aminoalkanephosphonates are, e.g. ethylenediaminetetramethylene-phosphonate (EDTMP), diethylenetriaminepentamethylenephosphonate (DTPMP), as well as higher homologs thereof. They are used preferably in the form of the neutrally reacting sodium salts, e.g. as a hexasodium salt of EDTMP resp. as a hepta- and octasodium salt of DTPMP. Of the class of the phosphonates, HEDP is preferably used as a builder. The aminoalkanephosphonates moreover possess a pronounced ability to bind heavy metals. It may accordingly be preferred, in particular if the agents also contain bleaches, to use aminoalkanephosphonates, in particular DTPMP, or mixtures of the aforesaid phosphonates.

Particularly preferred are one or more phosphonate(s) from the group of
a) aminotrimethylenephosphonic acid (ATMP) and/or salts thereof,
b) ethylenediaminetetra(methylenephosphonic acid) (EDTMP) and/or salts thereof,
c) diethylenetriaminepenta(methylenephosphonic acid) (DTPMP) and/or salts thereof,
d) 1-hydroxyethane-1,1-diphosphonic acid (HEDP) and/or salts thereof,
e) 2-phosphonobutane-1,2,4-tricarboxylic acid (PBTC) and/or salts thereof,
f) hexamethylenediaminetetra(methylenephosphonic acid) (HDTMP) and/or salts thereof,
g) nitrilotri(methylenephosphonic acid) (NTMP) and/or salts thereof.

Washing- or cleaning compositions that contain 1-hydroxyethane-1,1-diphosphonic acid (HEDP) or diethylenetriaminepenta(methylenephosphonic acid) (DTPMP) as phosphonates are particularly preferred.

The cleaning compositions according to the present invention can of course contain two or more different phosphonates.

Preferred cleaning compositions may contain at least one complexing agent from the group above in terms of the total weight of the cleaning agent in a range from 0.01 to 8.0 wt.-%, preferably 0.02 to 5.0 wt.-%, and in particular 0.05 to 3.0 wt.-%.

Builders and co-builders can generally be added to the composition in acid form, neutralized or in a partly neutralized form. When used in a partly or completely neutralized form alkali metal salts are preferred, like sodium, potassium and lithium or ammonium salts.

### Surfactants

The cleaning composition of the present invention preferably comprise one or more surfactants as at least one further ingredient. Said surfactants may be selected from anionic, non-ionic, cationic or amphoteric surfactants, however, are preferably anionic and/or non-ionic.

The main functions of surfactants are changing the surface tension, dispersing, foam controlling and surface modification.

A special type of surfactants used in automatic dishwasher cleaning compositions is a tarry-over' surfactant. A tarry-over' surfactant has the property that some amount of the surfactant used remains in the machine after the rinsing cycles to give a performance during the final rinsing cycle and the (optional) drying phase of the whole washing cycle of the dishwashing machine. This type of surfactant is described in EP 1 524 313 in more detail.

For automatic dishwasher cleaning compositions alkoxylated nonionic surfactants and Gemini surfactants are commonly used. The alkoxy groups mostly consist of ethyleneoxide, propyleneoxide and butyleneoxide or combinations thereof. Also amphoteric surfactants are known to be used in automatic dishwasher detergent compositions.

Alkyl poly glucoside surfactants can also be used in automatic dishwasher cleaning compositions, preferably in a low foaming form.

Examples of possible surfactant as at least one further ingredient can be selected from the group consisting of anionic, cationic, non-ionic as well as amphoteric surfactants, and preferably may be selected from the group consisting of anionic or non-ionic surfactants or mixtures thereof. More preferably, the composition of the present invention comprises a mixture of anionic and non-ionic surfactants. If surfactants are present in the composition of the present invention, their amount preferably may be in the range of from 0.1 to 50 wt.-%, more preferably of from 1 to 30 wt.-%, even more preferably of from 1.5 to 25 wt.-%, even more preferably of from 1.5 to 20 wt.-%, and most preferably of from 1..5 to 15 wt.-%, based on the whole composition. Preferably the composition comprises at least one nonionic surfactants and optionally at least one anionic surfactant, wherein the ratio of the combined amount of anionic surfactants to the amount of non-ionic surfactants preferably is greater than 1:1 and more preferably is in the range of from 1.1:1 to 5:1.

Anionic surfactants suitable to be used in detergents, in particular in combination with enzymes are well known in the state of the art and include for example alkylbenzenesulfonic acids or salts thereof and alkylsulfonic acids or salts thereof.

Suitable anionic alkylbenzene sulfonic or alkylsulfonic surfactants include in particular C₅-C₂₀, preferably C₁₀-C₁₆, even more preferably C₁₁-C₁₃ alkylbenzenesulfonates, in particular linear alkylbenzene sulfonates (LAS), alkylestersulfonates, primary or secondary alkenesulfonates, sulfonated polycarboxylic acids and any mixtures thereof. Alkylethersulfates may be used as well.

Further preferred surfactants are low foaming non-ionic surfactants. Washing or cleaning agents, particularly cleaning agents for dishwashing and among this preferably for automatic dishwashers, are especially preferred when they comprise non-ionic surfactants from the group of the alkoxylated alcohols. Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched residues in the form of the mixtures typically present in Oxo alcohol residues. Particularly preferred are, however, alcohol ethoxylates with linear groups from alcohols of natural origin with 6 to 22 carbon atoms, e.g. from coco-, palm-, tallow- or oleyl alcohol, and an average of 2 to 8 EO per mole alcohol. Exemplary preferred ethoxylated alcohols include C₁₂₋₁₄ alcohols with 3 EO or 4 EO, C₉₋₁₁ alcohols with 7 EO, C₁₃₋₁₅ alcohols with 3 EO, 5 EO or 7 EO, C₁₂₋₁₈ alcohols with 3 EO, 5 EO or 7 EO and mixtures thereof, such as mixtures of C₁₂₋₁₄ alcohols with 3 EO and C₁₂₋₁₈ alcohols with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 100 EO.

Accordingly, ethoxylated non-ionic surfactant(s) prepared from C₆₋₂₀ monohydroxy alkanols or C₆₋₂₀ alkylphenols or C₁₂₋₂₀ fatty alcohols and more than 12 mole, preferably more than 12 mole and especially more than 20 mole ethylene oxide per mole alcohol, are used with particular preference. A particularly preferred non-ionic surfactant is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these non-ionic surfactants, the so-called narrow range ethoxylates are particularly preferred.

Moreover, surfactant(s) that comprise one or more tallow fat alcohols with 20 to 30 EO in combination with a silicone defoamer are particularly preferably used.

Examples of preferred surfactants are selected from a group consisting of gemini surfactants with a short C-Chain (C8-C12) as spacer and two times 5-40EO groups as hydrophilic headgroups (e.g. Dehypon GRA, Dehypon E 127, Genapol EC 50, Genapol EC 65) and Long Chain (C12-22) high ethoxylateted (20-100EO) carry over surfactant Lutensol AT Types.

Further all surfactants commonly known to be used in cleaning compositions can be part of the composition, this includes all anionic, non-ionic, cationic and amphoteric surfactants known in the art. The present invention is not limited by any of the surfactants commonly used in automatic dishwashing compositions.

### Bleaching Agent(S)

The composition of the present invention preferably comprises one or more bleaching agent(s) as at least one further ingredient.

Bleaching agents can be used in a cleaning composition either alone or in combination with a bleach activator and/or a bleach catalyst. The function of the bleaching agent is the removal of bleachable stains and to achieve an antibacterial effect on the load and inside of the (dish)washing machine.

Bleaching agents that can be used in detergent compositions include, but are not limited to, active chlorine compounds, inorganic peroxygen compounds and organic peracids. Examples are sodium percarbonate, sodium perborate monohydrate, sodium perborate tetrahydrate, hydrogen peroxide, hydrogen peroxide based compounds, persulfates, peroxymonosulphate, peroxodisulphate, E-phthalimido-perox-caproic acid, benzoyl peroxide, sodium hypochlorite, sodium dichloroisocyanurate, etc. as well as mixtures thereof. At least one bleaching agent is selected from inorganic bleaching agents, preferably from sodium perborate or sodium percarbonate or a mixture thereof.

The weight proportion of the bleaching agent in terms of the total weight of the cleaning composition is preferably from 1 to 40 wt.-%, more preferably from 2 to 30 wt.-%, and most preferred from 3 to 20 wt.-%.

### Anti-Redeposition Agent(s)

The cleaning composition of the present invention may optionally comprise one or more anti-redeposition agent(s) as at least one further ingredient.

The main function of anti-redeposition agents is the aid to prevent the soil from redepositioning on the washing substrate when a washing liquor provides insufficient soil anti-redeposition capacity.

Anti-redeposition agent(s) can provide their effect by becoming adsorbed irreversibly or reversibly to the soil particles or to the substrate. Thereby the soil becomes better dispersed in the washing liquor or the substrate is occupied with anti-redeposition agent(s) on those places the soil could redeposit.

The anti-redeposition agent(s) that are known to be used in detergent compositions include, but are not limited to, carboxymethyl cellulose, polyester-PEG co-polymer, polyvinyl pyrrolidone based polymers etc.

### Anti-Corossion Agent(s)

The cleaning composition of the present invention may optionally comprise one or more anti-corrosion agent(s) as one further ingredient.

The main function of anti-corrosion agents is to minimize the amount of material damage caused on glass and metal during automatic dishwashing.

Glass corrosion occurs because metal ions are dissolved out of the glass surface. This occurs more intensively when soft tap water is used for the cleaning. In this case the builders and complexing agents can only bind a limited amount of hardness ions from the tap water and extract then (alkaline earth) metals from that glass surface. Also of influence for glass corrosion are the washing temperature, the quality of the glassware and the duration of the cleaning program.

Glass corrosion becomes visible in white lines or white clouds on the glass surface. The glass corrosion damage can be repaired by replacing the extracted metal ion, however preferably the glassware can be protected against glass corrosion.

Metal corrosion occurs in many cases when oxide, sulphide and/or chlorides are present in the washing liquid, which normally is a mixture of tap water, soil and a cleaning composition. The anions react with the metal or metal alloy surface of articles that are contained in the dishwashing machine. In the case of silver the silver salts which are formed give a discoloration of the silver metal surface which becomes visible after one or more cleaning cycles in an automatic dishwashing machine.

The occurrence of metal corrosion can be slowed down or inhibited by use of detergent ingredients that provides the metal with a protective film or ingredients forming compounds with the oxide, sulfide and/or chlorides to prevent them from reacting with the metal surface.

The protective film can be formed because the inhibitor ingredient may become insoluble on the metal or metal alloy surface, or because of adsorption to the surface by aid of free electron pairs of donor atoms (like N, S, O, P). The metals can be silver, copper, stainless steel, iron, etc.

The types of anti corrosion agents which often are used in detergent compositions or is which are described in literature include, but are not limited to, triazole-based compounds (like tolyltriazole and 1,2,3-benzotriazole), polymers with an affinity to attach to glass surfaces, strong oxidizers (like permanganate), cystine (as silver-protector), silicates, organic or inorganic metal salts, or metal salts of biopolymers. The metal of these metal salts can be selected from the group aluminum, strontium, barium, titanium, zirconium, manganese, lanthanum, bismuth, zinc, wherein the latter two are most commonly applied for the prevention of glass corrosion. Further compounds to be added e.g. are manganese compounds as described e.g. in WO2005/095570.

### Silver Protecting Agents

The cleaning composition of the present invention may optionally comprise one or more silver protecting agent(s) as one further ingredient.

Several silver protection agents that reduce silver corrosion have been described in the patent literature. The British patent GB 1131738 discloses dishwashing agents which use benzotriazoles as a corrosion inhibitor for silver. Benzotriazoles in the context of silver corrosion protection are also disclosed in the U.S. Pat. No. 2,549,539 and the European patents EP 135 226 and EP 135 227.

Another group of compounds used as silver corrosion protection agents comprises manganese salts or manganese complex compounds. The German patent number DE 4315397 discloses organic and anorganic redox compounds containing manganese(II) compounds, e.g. manganese(II)sulfate, manganese(II)acetoacetate and manganese(II)acetylacetonate. These low valent manganese compounds preferably have to be coated prior to their use in cleaning compositions containing bleaching agents in order to avoid their oxidation or decomposition during storage. EP 530 870 A1 discloses dinuclear manganese complexes in machine dishwashing compositions, wherein the manganese is in the III or IV oxidation state. EP 697 035 A1 describes automatic dishwashing compositions comprising at least partly water-soluble metal salts and/or metal complexes comprising manganese salts or complexes.

Examples of further corrosion inhibitors or anti-tarnish aids are paraffin oil, typically a predominantly branched aliphatic hydrocarbon having a number of carbon atoms in the range of from about 20 to about 50; preferred paraffin oil is selected from predominantly branched C 25-45 species with a ratio of cyclic to noncyclic hydrocarbons of about 32:68. A paraffin oil meeting those characteristics is sold by Wintershall, Salzbergen, Germany, under the trade name WINOG 70. When present, such protecting materials are preferably incorporated at low levels, e.g., from about 0,01 wt.-% to about 5 wt.-% of the automatic dishwashing composition.

Other corrosion inhibitor compounds include benzotriazole, tolyltriazole and comparable compounds; mercaptans or thiols including thionaphtol and thioanthranol; and finely divided Aluminium fatty acid salts, such as aluminium tristearate. The formulator will recognize that such materials will generally be used judiciously and in limited quantities so as to avoid any tendency to produce spots or films on glassware or to compromise the bleaching action of the compositions. For this reason, mercaptan anti-tarnishes which are quite strongly bleach-reactive and common fatty carboxylic acids which precipitate with calcium in particular are preferably avoided.

### Dyes

The composition of the present invention may optionally comprise one or more dyes as at least one further ingredient. The dye is used to colour the detergent, parts of the detergent or speckles in the detergent. This might render the product more attractive to the consumer.

Dyes that can be used in cleaning compositions include, but are not limited to, Nylosan yellow N-7GL, Sanolin brilliant flavine 8GZ, Sanolin yellow BG, Vitasyn quinoline yellow 70, Vitasyn tartrazine X90, Puricolor yellow AYE23, Basacid yellow 232, Vibracolor yellow AYE17, Simacid Eosine Y, Puricolor red ARE27, Puricolor red ARE14, Vibracolor red ARE18, Vibracolor red ARE52, Vibracolor red SRE3, Basacid red 316, Ponceau SX, Iragon blue DBL86, Sanolin blue EHRL, Sanolin turquoise blue FBL, Basacid blue 750, Iragon blue ABL80, Vitasyn blue AE90, Basacid blue755, Vitasyn patentblue V 8501, Vibracolor green AGR25. These dyes are available at the firms Clariant or BASF.

### Perfumes

The composition of the present invention may optionally comprise one or more perfumes as at least one further ingredient. The perfume is added to the cleaning composition to improve the sensorial properties of the product or of the machine load after cleaning.

The perfume can be added to the cleaning composition as a liquid, paste or as a co-granulate with a carrier material for the perfume. To improve the stability of the perfume it can be used in an encapsulated form or as a complex like for example a perfume-cyclodextrine complex.

Also perfumes that have a deodorizing effect can be applied. Such perfumes or raw materials encapsulate malodours by binding to their sulphur groups.

The composition may further comprise other ingredients allowing a desired performance as known by the skilled artisan without limiting the invention.

In a particularly preferred embodiment of the invention a cleaning composition comprises 0.01-10 wt.-% of granulate particles comprising a core and a coating, wherein the core comprises at least one metal containing bleach catalyst and at least one binder and optionally a bleach activator and the coating comprises at least one water soluble coating compound, wherein at least 2 wt.-% of the ingredients of the core are represented by the metal containing bleach catalyst and the binder, further said cleaning composition comprises 1-40 wt.-% of sodium percarbonate or sodium perborate, 0.1-10 wt.-% low-foaming non-ionic surfactant, 0.1-80 wt.-% builder and optionally 0.1-20 wt.-% sulfonic acid comprising polymer (wt.-% based on the entire cleaning composition).

In a preferred embodiment of the invention the cleaning composition is a dishwashing composition, preferably an automatic dishwashing composition.

In a further aspect the invention provides a method for cleaning tableware, glassware, dishware, cookware, flatware and/or cutlery in an automatic dishwashing appliance, said method comprising treating soiled tableware in an automatic dishwasher with a cleaning composition according to this invention or a solution comprising said cleaning composition.

In a further aspect of the invention said granular particles are used in a cleaning composition, preferably said cleaning composition is used for dishwashing.

### EXAMPLE

Co-granulates comprising 5 wt.-% MnTACN, 25 wt.-% CMC and 70 wt.-% TAED were coated as defined in table 1. After storage as shown in table 1 the granulate was added to an automatic dishwashing composition comprising builder, percarbonate, nonionic surfactant and sulfonic acid comprising copolymer, and the cleaning performance was tested and scored (% cleaning) with 100 g soil ballast (black tea).

TABLE 1
Bleaching performance of detergent compositions comprising
the co-granulates according to the invention (in %)

| | Storage time in weeks | | |
|---|---|---|---|
| | (0 weeks = 1 to 3 days) | | |
| Granulate coated with | 0 | 4 | 12 |
| Granulate uncoated | 70 | 25 | 28 |
| 10% citric acid | 65 | 40 | 40 |
| 20% citric acid | 68 | 41 | 40 |
| 30% citric acid | 73 | 40 | 39 |
| 40% citric acid | 70 | 41 | 40 |
| 10% mannitol | 80 | 46 | 43 |
| 20% mannitol | 80 | 48 | 42 |
| 30% mannitol | 80 | 48 | 45 |
| 40% mannitol | 80 | 49 | 45 |
| 10% Kollicoat Protect (1) | 75 | 62 | 70 |
| 20% Kollicoat Protect (1) | 78 | 64 | 70 |
| 20% Accusol 588 (2) | 98 | 80 | 78 |
| 20% Sodium citrate | 85 | 80 | 75 |
| 10% citric acid 10% Na citrate | 78 | 75 | 70 |

(1) Kollicoat Protect (BASF): copolymers of PVA and polyethylene glycol (PEG)
(2) Accusol 588 (Rohm & Haas): sulfonic acid/acrylic acid copolmer

1. A co-granule comprising:
(A) a core comprising:
a) at least one metal-containing bleach catalyst;
b) at least one binder;
optionally at least one bleach activator; and
(B) a coating comprising:
at least one of the components selected from:
(i) polyvinyl alcohol (PVA), copolymers of PVA and polyethylene glycol (PEG), polyvinyl acetate, polyvinylpyrrolidone, ethylenvinylalcohol, sodium lauryl sulfate; or
(ii) an acid component selected from acid polymers comprising sulfonic acid groups and carboxylic acids.

2. The co-granule according to claim 1, wherein the coating comprises at least one of the components selected from the group consisting of polyvinyl alcohol (PVA), copolymers of PVA and polyethylene glycol (PEG), copolymers of acrylic acid and sulfonic acid, citric acid/citrate and mixtures thereof.

3. The co-granule according to claim 2, wherein the coating comprises at least a copolymer comprising acrylic acid and sulfonic acid monomers, or citrate.

4. The co-granule according to claim 1, wherein the at least one bleach catalyst is selected from bleach catalysts containing manganese, iron, cobalt, ruthenium, molybdenum, titanium or vanadium; preferably the bleach catalyst is selected from manganese salts and/or manganese complexes, more preferably the bleach catalyst is Mn^{IV}₂(μ-O)₃(1,4,7-trimethyl-1,4,7-triazacyclononane)₂-(PF₆)₂(MnTACN).

5. The co-granule according to claim 1, further comprising:
at least one further component selected from stabilizers, rinsing aids, fluorescent agents, surfactants, pigments, colorants, suds suppressors, builders, perfumes, enzymes, silver protection agents, anti-tarnishing additives, anti-corrosion agents either in the core or in the coating, preferably in the core.

6. The co-granule according to claim 1, wherein the at least one binder b) is carboxymethyl cellulose and/or carboxymethyl cellulose derivatives.

7. The co-granule according to claim 1, wherein the at least one bleach activator is selected from the group consisting of tetraacetylethylenediamine (TAED), sodium nonanoyloxybenzene sulfonate (NOBS), acetyl caprolactone, N-methyl morpholinium acetonitrile and salts thereof, sodium 4-(2-decanoyl-oxyethoxycarbonyloxy)benzenesulfonate (DECOBS) and salts thereof, lauryloxybenzylsulfonate (LOBS), iso-lauryloxybenzylsulfonate (I-LOBS), N-methylmorpholinum-acetonitril (MMA), Pentaacetylglucose, Nitrilquats, Benzoylcaprolactam (BzCL), 4-nitrobenzoylcaprolactam, 3-clorobenzoylcaprolactam, benzoyloxybenzylsulfonate (BOBS), phenylbenzoate (PhBz), decanoyloxybenzylsulfonate (C10-OBS), benzoylvalerolactam (BZVL), octanoyloxybenzylsulfonate (C8-OBS), 4-[N-(nonanoyl)aminohezanoyloxy]-benzylsulfonate-sodium salt (NACA-OBS), 10-undecenoyloxybenzylsulfonate (UDOBS), decanoyloxybenzoec acid (DOBA), perhydrolyzable ester, perhydrolytic enzyme combined with an by this enzyme hydrolysable substrate, acetyl caprolactone, Acetyl caprolactam (N-acetylhexanelactam), N-methyl morpholinium acetonitrile and salts thereof, preferably the bleach activator is

8. The co-granule according to claim 1, wherein the core comprises
a) Mn^{IV}₂(μ-O)₃(1,4,7-trimethyl-1,4,7-triazacyclononane)₂-(PF₆)₂(MnTACN),
b) carboxymethyl cellulose, and
c) optionally tetraacetylethylenediamine (TAED).

9. The co-granule according to claim 1, wherein the co-granule further comprises:
d) a metal containing amino acid compound.

10. A detergent composition comprising the co-granule according to claim 1.

11. A detergent composition comprising: 0.01-10 wt-% of a co-granule according to claim 1;
1-50 wt-% of at least one anionic and/or nonionic surfactant;
0-50 wt-% of a cationic surfactant;
0-50 wt-% of alkalizing agent;
1-50 wt-% of at least one bleaching agent;
0.1 -80 wt-% of a builder, preferably citrate;
0-50 wt-% sulfonic acid group containing polymer;
0-20 wt-% anticorrosion agent;
0-20 wt-% silver protecting agent; and
0-20 wt-% further optional components including fluorescing agents, brightener, enzymes, perfumes.

12. The detergent composition according to claim 10, which is a cleaning composition, preferably a dishwashing cleaning composition

13. A method for cleaning a tableware in an automatic dishwashing process, comprising:
treating soiled dishes and a tableware in an automatic dishwasher with the cleaning composition claimed in claim 12 or a solution comprising said composition.

14. (canceled)

15. A method of producing the co-granule according to claim 1.

16. The co-granule according to claim 1, wherein said at least one binder is a cellulosic polymer.

17. The co-granule according to claim 1, wherein said at least one binder is selected from the group consisting of carboxymethyl cellulose hydroxypropyl cellulose hydroxypropylmethyl cellulose, and mixture thereof.

18. The co-granule according to claim 1, wherein the carboxylic acids are mono-, di- or tricarboxylic acids comprising 2 to 15 carbon atoms.

19. The co-granule according to claim 1, wherein the carboxylic acids are mono-, di- or tricarboxylic acids comprising 3 to 8 carbon atoms.
